(19) United States
(12) Patent Application Publication
(10) Pub. No.: US 2014/0008065 A1
(43) Pub. Date: Jan. 9, 2014

(54) FORMULATIONS BASED ON CRUDE GLYCEROL (CG), CELLULOSE ETHER AND UREA, PROCESS FOR PRODUCING MINERAL OIL FROM MINERAL OIL DEPOSITS HAVING INHOMOGENEOUS PERMEABILITY AND PROCESS FOR PRODUCING THESE FORMULATIONS

(71) Applicants: Institute of Petroleum Chemistry of the Siberian Branch of the Russian Academy, Tomsk (RU); Wintershall Holding GmbH, Kassel (DE)

(72) Inventors: Vladimir Stehle, Kassel (DE); Lubov Altunina, Tomsk (RU); Vladimir A. Kuvshivov, Tomsk (RU)

(73) Assignees: Institute of Petroleum Chemistry of the Siberian Branch of the Russian Academy, Tomsk (RU); Wintershall Holding GmbH, Kassel (DE)

(21) Appl. No.: 13/933,539

(22) Filed: Jul. 2, 2013

Related U.S. Application Data
(60) Provisional application No. 61/667,958, filed on Jul. 4, 2012.

(51) Int. Cl. C09K 8/58

(52) U.S. Cl. CPC C09K 8/58
USPC 166/275; 507/214

(57) ABSTRACT

The present invention relates to formulations (F) based on crude glycerol (CG), cellulose ether and urea, to a process for producing mineral oil from mineral oil deposits having inhomogeneous permeability and to a process for producing formulations (F) comprising crude glycerol (CG). The rheological properties of the inventive formulations (F) are modifiable within wide ranges, and can be adjusted to the geotechnical parameters, the environmental conditions and the nature of the mineral oil in different mineral oil deposits.

This patent application claims the benefit of pending U.S. provisional patent application Ser. No. 61/667,958 filed on Jul. 4, 2012, incorporated in its entirety herein by reference.

The present invention relates to formulations (F) based on crude glycerol (CG), cellulose ether and urea, to a process for producing mineral oil from mineral oil deposits having inhomogeneous permeability and to a process for producing formulations (F) comprising crude glycerol (CG). The rheological properties of the inventive formulations (F) are modifiable within wide ranges, and can be adjusted to the geotechnical parameters, the environmental conditions and the nature of the mineral oil in different mineral oil deposits.

In natural mineral oil deposits, mineral oil occurs in cavities of porous reservoir rocks which are closed off from the surface of the earth by impervious overlying strata. In addition to mineral oil, including proportions of natural gas, a deposit further comprises water with a higher or lower salt content. The cavities may be very fine cavities, capillaries, pores or the like, for example those having a diameter of only approx. 1 μm; the formation may additionally also have regions with pores of greater diameter and/or natural fractures, however. In a mineral oil deposit, one or more oil-bearing strata may be present.

After the well has been sunk into the oil-bearing strata, the oil at first flows to the production wells owing to the natural deposit pressure, and erupts from the surface of the earth. This phase of mineral oil production is referred to by the person skilled in the art as primary production. In the case of poor deposit conditions, for example a high oil viscosity, rapidly declining deposit pressure or high flow resistances in the oil-bearing strata, eruptive production rapidly ceases. With primary production, it is possible on average to produce only 2 to 10% of the oil originally present in the deposit.

Mineral oil production is differentiated into primary, secondary and tertiary production.

In order to enhance the yield, what are known as secondary production processes are therefore used. The most commonly used process in secondary mineral oil production is water flooding. This involves injecting water through injection wells into the oil-bearing strata. This artificially increases the deposit pressure and forces the oil out of the injection wells to the production wells. By water flooding, it is possible to substantially increase the yield level under particular conditions. It is additionally possible to increase the mineral oil yield further by measures of tertiary oil production. In tertiary oil production, suitable chemicals are used as assistants for oil production. This includes what is called “polymer flooding”. Polymer flooding involves injecting an aqueous solution of a thickening polymer into the mineral oil deposit through the injection wells instead of water. As a result of the injection of the polymer solution, the mineral oil is forced through said cavities in the formation from the injection well proceeding in the direction of the production well, and the mineral oil is finally produced through the production well. Due to the elevated viscosity of the polymer solution, which is matched to the viscosity of the mineral oil, the polymer solution is thus able to break through cavities at least not as easily as is the case for pure water, if at all. Parts of the deposit not accessible to the water are reached by the polymer solution.

In the ideal case of water flooding, a water front proceeding from the injection well should force the oil homogeneously over the entire mineral oil formation to the production well. In practice, a mineral oil formation, however, has regions with different levels of flow resistance. In addition to oil-saturated reservoir rocks which have fine porosity and a high flow resistance for water, there also exist regions with low flow resistance for water, for example natural or synthetic fractures or very permeable regions in the reservoir rock. Such permeable regions may also be regions from which oil has already been recovered. In the course of water flooding, the flooding water injected naturally flows principally through flow paths with low flow resistance from the injection well to the production well. The consequences of this are that the oil-saturated deposit regions with fine porosity and high flow resistance are no longer flooded, and that increasingly more water and less mineral oil is produced via the production well. In this context, the person skilled in the art refers to “watering out of production”. The effects mentioned are particularly marked in the case of viscous mineral oils.

For production of mineral oil from deposits with high mineral oil viscosity, the mineral oil can also be heated by injecting steam in the deposit, thus reducing the oil viscosity. As in the case of water flooding, however, steam and steam condensate can also strike undesirably rapidly through high-permeability zones from the injection wells to the production wells, as a result of which the efficiency of the production is reduced.

It is customary at present to conduct both steps when developing deposits containing viscous oil: water flooding followed by steam flooding. The blocking of the highly permeable channels, especially during steam flooding, is technologically difficult to implement due to the very high temperatures in the environment of the injection well.

The prior art discloses measures for closing such high-permeability zones between injection wells and production wells by means of suitable measures. As a result of these, high-permeability zones with low flow resistance are blocked and the flooding water or the flooding steam flows again through the oil-saturated, low-permeability strata. Such measures are also known as “conformance control”. An overview of measures for conformance control is given by Borling et al. “Pushing out the oil with Conformance Control” in Oilfield Review (1994), pages 44 ff.

For conformance control, it is possible to use comparatively low-viscosity formulations of particular chemical substances which can be injected easily into the formation, and the viscosity of which rises significantly only after injection into the formation under the conditions which exist in the formation. To enhance the viscosity, such formulations comprise suitable inorganic, organic or polymeric components. The rise in viscosity of the injected formulation can firstly occur with a simple time delay. However, there are also known formulations in which the rise in viscosity is triggered essentially by the temperature rise when the injected formulation is gradually heated to the deposit temperature in the deposit. Formulations whose viscosity rises only under formation conditions are known, for example, as “thermogels” or “delayed gelling systems”. However, these formulations can be employed efficiently only in deposits whose temperature is above 60° C.

SU 1 654 554 A1 discloses processes for producing oil, in which mixtures comprising aluminum chloride or aluminum nitrate, urea and water are injected into the mineral oil formations. At the elevated temperatures in the formation, the urea is hydrolyzed to carbon dioxide and ammonia. The ammonia which forms significantly increases the pH of the water, as a result of which high-viscosity aluminum hydroxide gel precipitates out, which blocks the high-permeability regions.

RU 2 339 803 C2 describes a process for blocking high-permeability regions in mineral oil deposits, in which the volume of the high-permeability region to be blocked is first of all determined. Subsequently, an aqueous formulation comprising carboxymethylcellulose and chromium acetate as a crosslinker is injected into the region to be blocked, the volume of the injected mixture being 15%, based on the total volume of the region to be blocked. In the next step, an aqueous formulation comprising polyacrylamide and a crosslinker is injected.

L. K. Altunina and V. A. Kushinov, Oil & Gas Science and Technology—Rev. IFP, Vol. 63 (2008), pages 37 to 48 and Altunina L. K., Kuvshinov V. A., Stasyeva L. A.//Thermoreversible Polymer Gels for Increased Efficiency of Cyclic-Steam Well Treatment,—2006—1 CD-ROM,—68th EAGE Conference & Exhibition “Opportunities in Marine Areas”, Paper D030 describe various thermogels and the use thereof for oil production, including thermogels based on urea and aluminum salt, and thermogels based on cellulose ethers.

The above-described gel-forming formulations are “thermogels”, i.e. formulations whose viscosity rises with increasing temperature. A disadvantage of these thermogels is that they can be used only in mineral oil deposits which have deposit temperatures of at least 60° C.

It was therefore an object of the present invention to provide formulations whose rheological and physical parameters are modifiable within wide ranges and allow efficient profile modification of the flood front. The formulations are to be usable flexibly both in mineral oil deposits having deposit temperatures above 60° C. and in mineral oil deposits having deposit temperatures below 60° C.

It was a further object of the present invention to provide a process for producing these formulations and to provide a process for producing mineral oil from mineral oil deposits having inhomogeneous permeability using these formulations. The processes for producing mineral oil are to be employable both in mineral oil deposits having temperatures above 60° C. and in mineral oil deposits having temperatures below 60° C.

This object is achieved by a process for producing mineral oil from underground mineral oil deposits into which at least one injection well and at least one production well have been sunk, comprising at least the following process steps:
1) injecting one or more flooding media into at least one injection well and withdrawing mineral oil through at least one production well,
2) blocking high-permeability zones of the mineral oil deposit in the region between the at least one injection well and the at least one production well by injecting at least one formulation (F) into the mineral oil deposit through the at least one injection well, and
3) continuing the injection of one or more flooding media into the injection well and withdrawing mineral oil through at least one production well,
   wherein the formulation (F) comprises 10 to 99.9% by weight of crude glycerol (GC), 0.1 to 3% by weight of cellulose ether and 0 to 60% by weight of water, where the percentages by weight are each based on the total weight of the formulation (F).

It has been found that, surprisingly, the rheological and physical properties of the formulation (F) can be modified and adjusted easily by simple variation of the component concentrations, especially of the concentration of crude glycerol (CG).

It is thus possible to adjust the formulations (F) in a simple manner to the geotechnical parameters and environmental conditions, i.e. more particularly to the deposit temperature and the viscosity of the oil present in the deposit. The inventive formulations (F) are especially suitable for use in mineral oil deposits having relatively high deposit temperatures (hot mineral oil deposits). The use of crude glycerol (CG) allows the gel formation temperature of the formulation (F) to be varied within wide ranges, such that the formulation (F) can also be used in the development of mineral oil deposits having a relatively low deposit temperature (cold mineral oil deposits). A further advantage of the inventive formulation (F) is that the freezing temperature can also be regulated within wide ranges. By varying the component contents, especially the concentration of crude glycerol (CG), it is possible to significantly reduce the freezing temperature. This enables the use of the formulation (F) in the development of mineral oil deposits in cold regions of the earth too, for example in permafrost regions.

### BRIEF DESCRIPTION OF THE DRAWING

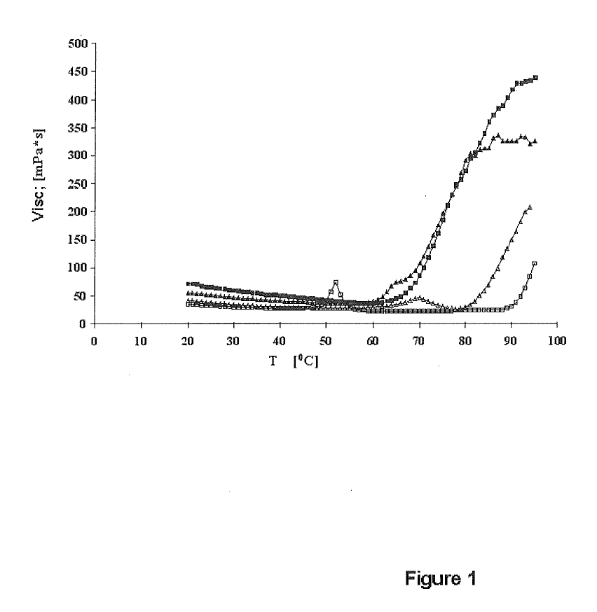

The diagram according to FIG. 1 shows the influence of crude glycerol (CG) on the gel formation temperature.

In the context of the present invention, cold mineral oil deposits are understood to mean deposits having temperatures <60° C. Hot mineral oil deposits are understood to mean deposits having a temperature of at least 60° C.

The formulations (F) are thermogels, which means that the viscosity of the formulation (F) rises when the temperature increases. The formulations (F) thus have a low viscosity at low temperatures, whereas the viscosity thereof rises significantly with increasing temperature.

The formulations (F) are especially suitable for use in hot deposits. However, it has been found in accordance with the invention that the use of crude glycerol (CG) can lower the gel formation temperature of the formulations (F) to such an extent that use is also possible in cold mineral oil deposits.

Glycerol is a trihydric alcohol (IUPAC name 1,2,3-propanetriol) having the formula CH₂(OH)—CH(OH)—CH₂(OH). Glycerol is produced by petrochemical means from propene via the allyl chloride and epichlorohydrin intermediates. Crude glycerol (CG) shall be understood in the context of the present invention to mean all mixtures comprising glycerol, water, inorganic salts and organic compounds (other than glycerol). Preference is given, however, to crude glycerol (CG) which is obtained from natural fats or oils. Glycerol is a constituent of all animal and vegetable fats/oils. Crude glycerol (CG) is obtained in large amounts as a by-product of biodiesel production. For production of biodiesel, vegetable oils, for example rapeseed oil, are transesterified with methanol. A fat/oil molecule (triacyl glyceride) is reacted with three methanol molecules to give glycerol and three fatty acid methyl esters. Thus, 10 liters of vegetable oil and 1 liter of methanol give approx. 10 liters of biodiesel and 1 liter of crude glycerol.

Crude glycerol (CG) preferably has the following composition:
80 to 90% by weight of glycerol,
10 to 20% by weight of water,
5 to 10% by weight of inorganic salts and
0 to 1% by weight of organic compounds, such as methanol,
   where the percentages by weight are each based on the total weight of the crude glycerol (CG).

Particular preference is given to crude glycerol (CG) having the following composition:
80 to 83% by weight of glycerol,
10 to 15% by weight of water,
5 to 7% by weight of inorganic salts comprising sodium chloride,
   where the percentages by weight are each based on the total weight of the crude glycerol (CG).

The inorganic salts are also referred to as ash. Ash constitutes the ignition residue of the crude glycerol (CG).

The crude glycerol (CG) may of course comprise further components which are obtained as impurities in the production of crude glycerol (CG). Preferably, the content of further components in the crude glycerol (CG), however, is below 1% by weight, more preferably below 0.5% by weight and especially below 0.1% by weight, based in each case on the total weight of the crude glycerol (CG).

Crude glycerol (CG) at 20° C. has a density of 1.23 to 1.27 g per cm³. The viscosity of crude glycerol (CG) at 20° C. is in the range from 700 mPa*s to 1200 mPa*s. The viscosity of the crude glycerol (CG) depends on the water content and any inorganic salts present in the crude glycerol (CG). The organic compounds present in crude glycerol (CG) are preferably methanol, especially in concentrations in the range from 0.01 to 0.5% by weight, based on the total weight of the crude glycerol (CG). The inorganic salts present are preferably sodium chloride and/or potassium chloride, especially in concentrations in the range from 5 to 7% by weight, based on the total weight of the crude glycerol (CG). Crude glycerol (CG) has the advantage that it is not of toxicological concern and is biodegraded. Crude glycerol (CG) can therefore also be used in ecologically sensitive areas as a constituent of a formulation for production of mineral oil.

In the last few years, the production of biodiesel, particularly in the European Union, has risen rapidly. The production of crude glycerol (CG) in the European Union has reached a volume of approximately 1 million tonnes. A viable use for the crude glycerol (CG) obtained in biodiesel production is a great economic problem which has not been solved to date. The invention enables a viable use of the wastes obtained in biodiesel production (crude glycerol (CG)). Crude glycerol (CG) additionally has the advantage of being available inexpensively and in large volumes.

The invention further provides for the use of crude glycerol (CG) as part of a formulation (F) for blocking of high-permeability regions (zones) of a mineral oil deposit, especially in the region between at least one injection well and at least one production well of the mineral oil deposits.

The invention further provides for the use of a formulation (F) for blocking of high-permeability zones of a mineral oil deposit.

### Formulation (F)

The formulation (F) comprises crude glycerol (CG) preferably in amounts of 10 to 99.9% by weight, more preferably in the range from 15 to 99.9% by weight and especially in the range from 30 to 99.9% by weight.

The formulation (F) may, as well as cellulose ethers (0.1 to 3% by weight), additionally comprise water in amounts of 0 to 60% by weight, based in each case on the total weight of the formulation (F).

The formulation (F) may additionally comprise urea. In this case, the formulation (F) is generally used as an aqueous solution comprising 10 to 50% by weight of crude glycerol (CG), 0.1 to 2.5% by weight of cellulose ether and 2 to 40% by weight of urea, each based on the total weight of the formulation (F).

Preference is given to formulations (F) comprising
10 to 50% by weight of crude glycerol (CG),
0.1 to 2.5% by weight of cellulose ether,
2 to 40% by weight of urea,
1 to 60% by weight of water and
1 to 20% by weight of sodium chloride and/or calcium chloride,
   each based on the total weight of the formulation (F).

Among the above-described formulations (F), particular preference is given to those comprising at least 10% by weight of crude glycerol (CG), and especially preferred formulations (F) are those which comprise 10 to 40% by weight of crude glycerol (CG), each based on the total weight of the formulation (F).

The formulation (F) may further comprise further additives, for example surfactants, or polymers other than cellulose ethers.

However, the formulation (F) preferably comprises not more than 1% by weight, more preferably not more than 0.5% by weight and especially not more than 0.1% by weight of further additives, based in each case on the total weight of the formulation (F).

The percentages by weight of the individual components of the formulation (F) are generally selected such that the sum thereof adds up to 100% by weight. Preference is given to formulations (F) which consist of the above-described components.

The percentages by weight of water and optionally of sodium chloride and/or calcium chloride in the formulation (F) do not include the amount of the water and any amounts of sodium chloride and/or calcium chloride already present in the crude glycerol (CG). The percentages by weight of water and sodium chloride and/or calcium chloride in the formulation (F) should be understood as additional amounts of water and sodium chloride and/or calcium chloride. To calculate the total amount of the amount of water present in the formulation (F), the amount of water present in the crude glycerol (CG) and the amount of water additionally added should thus be added up. To calculate the total amount of sodium chloride and/or calcium chloride in the formulation (F), the amounts of sodium chloride and/or calcium chloride present in the crude glycerol (CG) and the amounts of sodium chloride and/or calcium chloride additionally added should likewise be added up.

The additional addition of sodium chloride and/or calcium chloride increases the density of the formulation (F). Furthermore, the additional addition of sodium chloride and/or calcium chloride can modify the rheological properties of the formulation (F). It is especially possible to reduce the gel formation temperature of the formulation (F) by the addition of sodium chloride and/or calcium chloride. The addition of the salts can modify the density of the formulation (F) and/or adjust it to the density of the mineral oil present in the mineral oil deposit.

Preference is given to the addition of calcium chloride.

The cellulose ethers used may be all known cellulose ethers obtainable by partial or full substitution of the hydrogen atoms of the hydroxyl groups of cellulose. Suitable groups for substitution of the hydrogen atoms are, for example, alkyl and/or aryl groups. The etherification of the cellulose is generally performed by reaction with the respective halides (for example with methyl, ethyl, propyl or benzyl chloride), with epoxides (for example ethylene, propylene or butylene oxide) or with activated olefins (for example acrylonitrile, acrylamide or vinylsulfonic acid). Preferred cellulose ethers are, for example, methyl cellulose, methyl hydroxyethyl cellulose or methyl hydroxypropyl cellulose, and mixtures of these cellulose ethers. Particular preference is given to methyl cellulose or methyl hydroxypropyl cellulose, and to mixtures of these two cellulose ethers.

The formulation (F) can advantageously be used for profile modification of the flood front in mineral oil deposits having deposit temperatures in the range from 40 to 150° C. The formulation (F) penetrates deep into the high-permeability zones of the mineral oil deposit before gel formation sets in. In the case of gel formation (gelation) of the formulation (F), immobile gel banks form in the mineral oil deposit, and these block the high-permeability regions of the mineral oil deposit and bring about profile modification.

“Gel” in relation to the formulation (F) is understood in the present context to mean that the formulation, with exclusion of shear stress (shear rate=0 s⁻¹) or under the action of low shear rates in the range from 0.1 to 5 s⁻¹, behaves virtually like a solid. According to the invention, the formulation (F) is referred to as a gel when it does not run out of a tilted beaker over a period of at least 0.25 hour, preferably at least 0.5 hour, more preferably at least 1 hour and especially preferably at least 2 hours. The determination can be effected by the following simple test. A 250 ml beaker (DIN 12331, ISO 3819) with external diameter of 70 mm and a height of 95 mm is filled with 125 ml of the formulation (F) and adjusted to the desired temperature. Subsequently, the beaker, with avoidance of agitation, is moved by tilting by 90° from the vertical position to a horizontal position, while maintaining the temperature. Subsequently, the time needed by the formulation (F) to escape over the edge of the beaker is measured.

The inventive formulations (F) in gelated form generally have a yield point. The formulations (F) in gelated form are generally structurally viscous, which means that the viscosity of the formulations (F) in gelated form decreases with rising shear rate. The viscosity of the formulations (F) is measured at shear rates in the range from 0.5 to 1.5 s⁻¹.

The gel formation temperature is understood to mean the temperature at which the viscosity of the formulation (F) rises suddenly and the formulation (F) forms a yield point.

The rise in the viscosity which indicates the gel formation temperature can be determined by measuring the viscosity of the formulation (F) as a function of temperature and then plotting the viscosity against temperature. The viscosity is plotted in a linear manner in mPa*s. The temperature is plotted in a linear manner in the unit ° C. The gel formation temperature is defined by the point of the curve at which the viscosity of the formulation (F) begins to rise with increasing temperature over a temperature range of at least 10° C.

Freezing temperature is understood to mean the temperature at which the formulation (F) solidifies, i.e. forms a solid.

### Process for Preparing the Formulation (F)

The present invention also provides a process for preparing the inventive formulation (F), comprising the steps of:
a) wetting a cellulose ether with water having a temperature in the range from 60 to 80° C. to obtain a mixture,
b) adding water having a maximum temperature of 20° C. to the mixture from step a) to obtain a solution and
c) adding crude glycerol (CG) to the solution from step b) to obtain the formulation (F),
   with addition of urea prior to step c).

“Prior to step c)” means that urea is added prior to step a), during step a), during step b), after step b) and/or between step a) and step b).

The amounts of crude glycerol (CG), urea, cellulose ether and water are selected such that the formulation (F) obtained in step c) has the inventive concentrations.

The addition of urea can be effected during step a); in a preferred embodiment, the cellulose ether is initially charged together with urea and then the water is added with a temperature in the range from 60 to 80° C. for wetting. It is also possible to initially charge the cellulose ether and to wet it with water, and then to add the urea. It is also possible first to wet the cellulose ether with water and to add the urea dissolved with the water having a maximum temperature of 20° C. in step b). In addition, it is possible to add the urea after step b).

In a preferred embodiment, the cellulose ether together with urea is wetted with hot water having a temperature in the range from 60 to 80° C., the volume of the hot water being 0.2 V to 0.5 V where V is the final volume of the formulation (F). In the case that the formulation (F) additionally comprises sodium chloride and/or calcium chloride, sodium chloride and/or calcium chloride is additionally added in the process for preparing the formulation (F), in which case the remarks regarding addition of urea apply correspondingly to the addition of these salts. In a preferred embodiment, the addition of salts such as sodium chloride and/or calcium chloride in step b) is effected together with the addition of water. In a particularly preferred embodiment, sea water or formation water in which the desired amounts of sodium chloride and/or calcium chloride are already present may be used.

The process according to the invention for preparing the formulation (F) has the advantage that no sparingly soluble precipitates form in the case of compliance with the addition sequence. The formation of these precipitates is especially prevented by adding crude glycerol (CG) as the last component of the formulation (F). In a preferred embodiment, the formulation (F) comprises not more than 45% by weight, more preferably not more than 40% by weight, based in each case on the total weight of the formulation (F). As a result, a homogeneous formulation (F) can be obtained. The use of greater amounts of crude glycerol (CG) is also possible, but an inhomogeneous solution is obtained in these cases.

Process for Producing Mineral Oil from an Underground Mineral Oil Deposit:

The use of the formulation (F) in a process for producing mineral oil from an underground mineral oil deposit allows watering-out of production to be reduced and the level of oil recovery from the mineral oil deposit to be enhanced.

The present invention thus also provides a process for producing mineral oil from underground mineral oil deposits, into which at least one injection well and at least one production well have been sunk, comprising at least the following process steps:
1) injecting one or more flooding media into at least one injection well and withdrawing mineral oil through at least one production well,
2) blocking high-permeability zones of the mineral oil deposit in the region between the at least one injection well and the at least one production well by injecting at least one formulation (F) into the mineral oil deposit through the at least one injection well, and
3) continuing the injection of one or more flooding media into the injection well and withdrawing mineral oil through at least one production well.

In a preferred embodiment, the formulation (F) in the mineral oil deposit forms a gel.

Due to the low gel formation temperature of the formulation (F), the process according to the invention can be employed both for hot mineral oil deposits and for cold mineral oil deposits.

The process according to the invention has the advantage that, even in deposits with low temperature, high-permeability zones can be blocked selectively by means of the formulation (F). The process enables blockage even of washed-out rock zones in the deposit which have been cooled (for example by water flooding). The distance between the borehole (the injection well) and the gel bank can be regulated in the process according to the invention particularly through the amount of crude glycerol (CG). This achieves efficient blocking of high-permeability zones, reduces watering-out of production and increases the level of oil recovery.

The process according to the invention for producing mineral oil is a process for secondary or tertiary mineral oil production, i.e. it is employed after primary mineral oil production has stopped due to the autogenous pressure of the deposit and the pressure in the deposit has to be maintained by injection of water and/or steam (secondary production) or by injection of an aqueous polymer solution (tertiary production).

### Deposits

The deposits may be deposits for all kinds of oil, for example those for light or heavy oil. In one embodiment of the invention, the deposits are heavy oil deposits, i.e. deposits comprising mineral oil having an API gravity of less than 22.3° API.

To execute the process, at least one production well and at least one injection well are sunk in the mineral oil deposits. In general, a deposit is provided with several injection wells and with several production wells.

The initial deposit temperature, i.e. the temperature prior to step (2) of the process according to the invention, is typically 20 to 200° C., preferably 30 to 180° C., more preferably 40 to 150° C., measured at the injection well. The deposit temperature changes as a result of the employment of the process according to the invention typically at least within the region between the injection wells and the production wells.

### Process

According to the invention, the process comprises at least three process steps (1), (2) and (3), which are executed in this sequence, but not necessarily in immediate succession. The process may of course comprise further process steps which can be executed before, during or after steps (1), (2) and (3).

### Process Step (1)

In a first process step (1), one or more flooding medias such as nitrogen, carbon dioxide, water, and water comprising the customary additives known to those skilled in the art such as thickeners and surfactants, preferably water or water comprising additives, are injected into the at least one injection well and mineral oil is withdrawn through at least one production well. The term “mineral oil” in this context does not of course mean single-phase oil, but means the customary emulsions which comprise oil and formation water and are produced from mineral oil deposits.

The water preferably injected as a flooding medium typically has a temperature of 5 to 60° C., preferably of 5 to 50° C. and more preferably of 5 to 40° C.

The injection of water forms a zone in which oil is displaced by water in the region between the injection well and the production well.

The injection of flooding media such as water can alter the original deposit temperature, i.e. it can be increased or lowered according to whether the flooding medium injected has a higher or lower temperature than the original temperature of the deposit.

The injection of a flooding medium such as water increases the pressure in the deposit, and zones in which oil is displaced by the flooding medium form in the region between the injection well and the production well.

As a result of the natural inhomogeneity of the permeability of the deposit, the “washed-out” zones having high permeability form within a certain time between the injector (injection well) and producer (production well). These zones may have a wide variety of different geometries and dimensions and are very difficult to predict. These zones are often located at the small geological faults which cannot be discovered with conventional analysis methods and analysis instruments, or at particular rock strata.

When watering-out of production rises relatively rapidly after the commencement of water flooding, this is a clear indication of a water breakthrough.

### Process Step (2)

Process step (2) can be employed as soon as production experiences excessive watering-out, or what is called a water breakthrough is registered. This is generally the case when a mixture comprising more than 70% by weight, particularly more than 90% by weight, of deposit water is withdrawn from the production well, based on the total weight of the mixture withdrawn from the production well. In the event of a water breakthrough, water flows through high-permeability zones from the injection well to the production well. Highly permeable zones, however, need not necessarily be obtained as a result of the water flooding, but may also be present naturally in a formation. In addition, it is possible that permeable zones have already been created in a process step preceding the process according to the invention.

For preparation for process step (2), it may be advantageous to measure the temperature in the region of the injection well and to determine the temperature range of the deposit in the region under the influence of flooding. Methods for determining the temperature range in a mineral oil deposit are known in principle to those skilled in the art. The temperature distribution is generally undertaken from temperature measurements at particular sites in the formation in combination with simulation calculations, and the simulation calculations take account of factors including amounts of heat introduced into the formation and the amounts of heat removed from the formation. Alternatively, each of the regions may also be characterized by the average temperature thereof. It is clear to the person skilled in the art that the analysis of the temperature range outlined constitutes merely an approximation of the actual conditions in the formation.

Process step (2) can be carried out directly after process step (1).

In the course of process step (2), highly permeable zones of the mineral oil deposit in the region between the injection wells and the production wells are blocked by injecting the formulation (F) through the at least one injection well.

According to the invention, at least one formulation (F) is used for this purpose. It is also possible to successively inject two or more formulations (F) of different composition.

According to the invention, in process step (2), the formulation (F) is injected into the mineral oil deposit through one or more injection wells. The injection of the formulation (F) may optionally be followed by further water flooding in order to displace the formulation (F) further into the mineral oil deposit. In the context of the present invention, further flooding refers to the water volume which is injected directly after the injection of the formulation (F) in order to bring the formulation (F) to the desired site in the mineral oil deposit underground. After further flooding, a flooding break is typically inserted for one to three days.

In order not to disrupt gelation (gel formation of the formulation (F)) in the mineral oil deposit as a result of shear stresses, the injection of the formulation (F) (process step (2)) may be followed by insertion of a flooding break in order to promote gel formation.

This means that, between the end of process step (2) and the continuation of the injection of one or more flooding media (process step (3)), a break for one to three days can be inserted. In the case that the formulation (F) is injected further into the mineral oil deposit underground by further flooding with water, the further flooding may be followed and the continuation of the injection of one or more flooding media according to process step (3) may be preceded likewise by insertion of a flooding break of one to three days.

### Process Step (3)

After process step (2) and optionally after the further flooding, the mineral oil production in process step (3) is continued through at least one production well. This can be effected immediately after process step (2). It is also possible to delay the performance of process step (3) for one to three days in order to promote gel formation of the formulation (F) in the mineral oil deposit.

The oil production in process step (3) can be performed by customary methods, for example by injection of one or more flooding media through at least one injection well into the mineral oil deposit, and crude oil is withdrawn from the at least one production well. The flooding medium may especially be selected from flooding media listed as suitable for process step (1). Preference is given to using water and/or water comprising additives as the flooding medium. It is also possible to use sea water or partly demineralized sea water. In addition, the flooding medium used in process step (3) may also be water which has been produced from the mineral oil deposit (called deposit water or formation water). Sea water, partly demineralized sea water and deposit water can also be used as a flooding medium in process step (1).

The at least one injection well through which the flooding medium is injected in process step (3) may be the injection well already used for injection of the formulation (F). It is also possible to inject the flooding medium in process step (3) through another suitable injection well. In addition, it is possible to inject the flooding medium into the mineral oil deposit in process step (3) through the injection well used in process step (2) and further injection wells.

The mineral oil production can of course also be continued by means of other methods known to those skilled in the art. For example, the flooding medium used may also be aqueous solutions of silicate-containing substances or thickening polymers (tertiary production). These may be synthetic polymers, for example polyacrylamide or acrylamide-comprising polymers. In addition, it is also possible to use biopolymers, for example polysaccharides.

It is also possible, after process step (3), to perform process steps (2) and (3) once again. This can be effected at regular intervals, for example once per year. In general, process step (2) is repeated when a water breakthrough is registered in mineral oil production in process step (3) from the production well. More particularly, process step (2) is repeated when critical watering-out of production is attained in mineral oil production in process step (3). This is the case typically when watering-out of production is above 70 to 90% by weight. This means that a mixture comprising 70 to 90% by weight of deposit water, based on the total weight of the mixture withdrawn from the production well, is withdrawn from the production well.

### Advantages

The process according to the invention for mineral oil production has the advantages which follow. The components present in formulation (F) are biodegradable and ecologically very substantially safe. The use of crude glycerol (CG) allows the gel formation temperature of the formulation (F) to be regulated within wide ranges, such that the formulation (F) can also be used in mineral oil deposits unsuitable for the use of the thermogels described in the prior art. The process according to the invention for producing mineral oil enables the blockage of permeable regions and channels in the mineral oil deposit, as a result of which water breakthrough is blocked. This is also possible at a relatively large distance from the injection well. With the process according to the invention, it is additionally possible to very substantially prevent gel formation in the injection well, as a result of which the reliability of mineral oil production is enhanced. The process according to the invention is additionally inexpensive, especially through the use of crude glycerol (CG), and allows efficient profile modification even in mineral oil deposits with relatively low temperatures.

The invention is illustrated in detail by the working examples which follow.

### EXAMPLE 1

The physical and rheological properties of aqueous formulations are shown below (table 1).

Formulations no. 1, 2 and 3 are noninventive formulations (comparative examples). Formulations no. 4 and 5 are inventive formulations (F).

The formulations were produced by the process according to the invention, i.e. methyl cellulose and urea were initially charged and wetted with hot water. Subsequently, cold water was added while stirring. Subsequently, crude glycerol (CG) was added.

TABLE 1

| | | Density | | Viscosity | Gel formation |
|---|---|---|---|---|---|
| | Composition | at 20° C. | | at 20° C. | temperature |
| No. | [% by wt] | g/cm³ | pH | [mPa * s] | [° C.] |
| 1 | 1 Culminal MC | 1.012 | 7.2 | 28.6 | 73 |
| | 2000S 2 urea | | | | |
| 2 | 1 Culminal MC | 1.034 | 7.4 | 34.0 | 79 |
| | 2000S 10 urea | | | | |
| 3 | 1 Culminal MC | 1.056 | 7.6 | 39.8 | 88 |
| | 2000S 20 urea | | | | |
| 4 | 1 Culminal MC | 1.118 | 7.3 | 57.2 | 57 |
| | 2000S 10 urea | | | | |
| | 35 crude | | | | |
| | glycerol (CG) | | | | |
| 5 | 1 Culminal MC | 1.147 | 7.7 | 75.6 | 60 |
| | 2000S 20 urea | | | | |
| | 35 crude | | | | |
| | glycerol | | | | |

Formulations no. 1 to 5 comprise water, in each case the difference of the components specified from 100% by weight.

The methyl cellulose used was Culminal MC 2000S from Aqualon.

Inventive formulations (F) no. 4 and 5 show that the use of crude glycerol (CG) can distinctly lower the gel formation temperature. The viscosities of the formulations were measured on a Haake RheoStress MCR 301 at a shear rate of 0.5 to 1.5 s⁻¹.

The crude glycerol (CG) used was a crude glycerol having the following composition:

Glycerol content: 82.3%

Water: 10.5%

Salts, NaCl, as ash: 6.0%

Sodium content: 2.2%

Methanol content: 0.0%

Density: 1.240 g/cm³

The ash refers in the present context to the ignition residue.

### EXAMPLE 2

Table 2 shows the physical and rheological properties of formulations (F) according to the invention. To produce formulations (F) no. 6, 7, 8 and 9, 1 g of Culminal MC 2000S in each case was initially charged together with the stated amount of urea. Urea and cellulose were subsequently wetted with 10 to 20 g of water at a temperature of 65° C. The composition was stirred until a homogeneous mixture had formed. Subsequently, cold water (34 to 44 g) was added to this mixture while stirring. The cold water was at a temperature of 17° C. The stirring was continued until all components had dissolved in water. Subsequently, 35 g of crude glycerol (CG) were added, likewise while stirring. This process was used to produce the inventive formulations (F) no. 6, 7, 8 and 9 below. The composition, density, pH and viscosity of the solution at 20° C. are reproduced in table 2 below.

TABLE 2

| | | | | Viscosity |
|---|---|---|---|---|
| | Composition | Density at | | at 20° C. |
| No. | [% by wt] | 20° C. [g/cm³] | pH | [mPa * s] |
| 6 | 1 Culminal MC 2000S | 1.118 | 7.25 | 57.2 |
| | 10 urea | | | |
| | 35 crude glycerol (CG) | | | |
| | 54 water | | | |
| 7 | 1 Culminal MC 2000S | 1.147 | 7.7 | 75.6 |
| | 20 urea | | | |
| | 35 crude clycerol (CG) | | | |
| | 44 water | | | |
| 8 | 1 Culminal MC 2000S | 1.130 | 7.4 | 63.0 |
| | 10 urea | | | |
| | 40 crude glycerol (CG) | | | |
| | 49 water | | | |
| 9 | 1 Culminal MC 2000S | 1.160 | 7.6 | 87.4 |
| | 20 urea | | | |
| | 40 crude clycerol (CG) | | | |
| | 39 water | | | |

The viscosity of the formulations (F) was measured on a Haake RheoStress MCR 301 at a shear rate in the range from 0.5 to 1.5 s¹.

The diagram according to FIG. 1 shows the influence of crude glycerol (CG) on the gel formation temperature. Plotted on the ordinate (Y-axis) is the viscosity (visc.) in mPa*s; plotted on the abscissa (X-axis) is the temperature in ° C. The curve with the black filled triangles shows the viscosity profile of a formulation (F) comprising 1% by weight of Culminal MC 2000S, 10% by weight of urea, 35% by weight of crude glycerol (CG) and 54% by weight of water. The curve with the black filled squares shows a formulation (F) comprising 1% by weight of Culminal MC 2000S, 20% by weight of urea and 35% by weight of crude glycerol (CG). The curves with the unfilled triangle and the unfilled square show noninventive formulations in which the crude glycerol (CG) has been replaced by water. In the curves in FIG. 1, the gel formation temperature is clearly discernible. The gel formation temperature is characterized by the temperature from which the viscosity has a positive slope over a temperature range of at least 10° C.

It is clearly visible from the viscosity curves in FIG. 1 that the use of crude glycerol (CG) leads to distinct lowering of the gel formation temperature.

1.-13. (canceled)

14. A process for producing mineral oil from underground mineral oil deposits into which at least one injection well and at least one production well have been sunk, comprising at least the following process steps:
1) injecting one or more flooding media into at least one injection well and withdrawing mineral oil through at least one production well,
2) blocking high-permeability zones of the mineral oil deposit in the region between the at least one injection well and the at least one production well by injecting at least one formulation (F) into the mineral oil deposit through the at least one injection well, and
3) continuing the injection of one or more flooding media into the injection well and withdrawing mineral oil through at least one production well,
wherein the formulation (F) comprises 10 to 99.9% by weight of crude glycerol (GC), 0.1 to 3% by weight of cellulose ether and 0 to 60% by weight of water, where the percentages by weight are each based on the total weight of the formulation (F).

15. The process according to claim 14, wherein the formulation (F) comprises
10 to 50% by weight of crude glycerol (CG),
0.1 to 2.5% by weight of cellulose ether,
2 to 40% by weight of urea and
1 to 60% by weight of water,
where the percentages by weight are each based on the total weight of the formulation (F).

16. The process according to claim 14, wherein the formulation (F) additionally comprises 1 to 20% by weight of sodium chloride and/or calcium chloride.

17. The process according to claim 14, wherein the crude glycerol (CG) has the following composition:
80 to 90% by weight of glycerol,
10 to 20% by weight of water,
0 to 10% by weight of inorganic salts and
0 to 1% by weight of organic compounds,
where the percentages by weight are each based on the total weight of the crude glycerol (CG).

18. The process according to claim 14, wherein the crude glycerol (CG) has the following composition:
80 to 82% by weight of glycerol,
10 to 15% by weight of water,
5 to 7% by weight of sodium chloride and
0.01 to 0.5% by weight of methanol,
where the percentages by weight are each based on the total weight of the crude glycerol (CG).

19. The process according to claim 14, wherein the formulation (F) comprises 10 to 40% by weight of crude glycerol (CG).

20. The process according to claim 14, wherein the cellulose ether is methyl cellulose, methyl hydroxypropyl cellulose or a mixture of methyl cellulose and methyl hydroxypropyl cellulose.

21. The process according to claim 14 wherein the formulation (F) forms a gel in the high-permeability zones of the mineral oil deposit.

22. A process for producing the formulation (F), comprising the steps of:
a) wetting a cellulose ether with water having a temperature in the range from 60 to 80° C. to obtain a mixture,
b) adding water having a maximum temperature of 20° C. to the mixture from step a) to obtain a solution and
c) adding crude glycerol (CG) to the solution from step b) to obtain the formulation (F),
with addition of urea prior to step c).

23. The process according to claim 22, wherein the volume of the water used in step a) is 0.2 to 0.5 V where V is the final volume of the formulation (F).

24. The process according to claim 22, wherein cellulose is initially charged together with urea in step a).

25. The process according to claim 22, wherein the urea is added dissolved with the water in step b).

26. A formulation (F) comprising
10 to 50% by weight of crude glycerol (CG),
0.1 to 2.5% by weight of cellulose ether,
2 to 40% by weight of urea and 1 to 60% by weight of water,
where the percentages by weight are each based on the total weight of the formulation (F).
